(19) United States
(12) Patent Application Publication
(10) Pub. No.: US 2024/0065228 A1
(43) Pub. Date: Feb. 29, 2024

(54) LOCKING ASSEMBLY FOR ROPE AND PET LEASH

(71) Applicants: Qiyun Chen, Shenzhen (CN); Chuanchi Ruan, Maoming (CN); Qinzhun Xie, Chaozhou (CN)

(72) Inventors: Qiyun Chen, Shenzhen (CN); Chuanchi Ruan, Maoming (CN); Qinzhun Xie, Chaozhou (CN)

(21) Appl. No.: 17/895,074

(22) Filed: Aug. 25, 2022

(51) Int. Cl. A01K 27/00

(52) U.S. Cl. CPC A01K 27/003

(57) ABSTRACT

The present application provides a locking assembly for a rope and a pet leash. The locking assembly for a rope comprises a lock sleeve and a locking piece, wherein the lock sleeve is provided with a threading hole through which the rope can pass, and the locking piece is movably arranged on the lock sleeve, and the locking piece can lock or unlock the lock sleeve on the rope through movement, and the lock sleeve is also provided with at least one locking opening; the present application also provides a pet leash, which comprises a locking assembly consisting of a lock sleeve and a locking piece and a rope, wherein one end of the rope is connected to a pet harness or collar, and the other end of the rope is provided with a lock catch which can be buckled on the lock opening of the lock sleeve; the locking assembly composed of the lock sleeve and the locking piece can quickly realize the locking or unlocking between the lock sleeve and the rope through the movement of the locking piece on the lock sleeve. The locking force is adjustable, and after locking, the locking piece is no longer stressed. The locking assembly is suitable for use on a pet leash. After the locking piece is locked, the locking piece will not loosen in the pulling process, and the locking effect is good.

### TECHNICAL FIELD

The present application relates to a locking assembly for a rope and a pet leash.

### BACKGROUND

With the continuous improvement of people's living standards, more and more people will keep pets to spend their spare time. Pets can accompany their owners to bring them some spiritual pleasure. Most of the common family pets are dogs or cats, especially dogs, which often need to walk outside, so they need to use a pet leash. Because pets are generally strong, they tend to get sore hands after walking for a long time, or because the owner has something temporary, in order to prevent pets from leaving their original place, it is necessary to tie the leash to other fixed objects, such as trees or stools. The existing leash for pets is not easy to tie, so it is necessary to tie the leash, otherwise, pets are easily lost.

### SUMMARY

In view of the shortcomings in the above problems, the present application provides a locking assembly for a rope and a pet leash.

On the one hand, the present application provides a locking assembly, including a lock sleeve and a locking piece, wherein the lock sleeve is provided with a threading hole through which a rope can pass, and the locking piece is movably arranged on the lock sleeve, and the locking piece locks or unlocks the lock sleeve on the rope through movement, and the lock sleeve is also provided with at least one locking opening.

As a further improvement of the present application, the locking piece is a screw, the lock sleeve is provided with a matching threaded hole corresponding to the screw, the locking opening is arranged below the threading hole in parallel, the locking opening is flat, and the lock opening runs through the lock sleeve.

As a further improvement of the present application, the locking piece is a screw, the lock sleeve is provided with a matching threaded hole corresponding to the screw, the lock sleeve has an integrally formed extension plate, the locking opening is formed on the extension plate, and the lock opening is crescent-shaped.

On the other hand, the present application provides a pet leash, including the locking assembly consisting of a lock sleeve and a locking piece and a rope, wherein one end of the rope is connected to a pet harness or collar, and the other end of the rope is provided with a lock catch which can be buckled on the lock opening of the lock sleeve.

Compared with the prior art, the present application has the beneficial effects that the locking assembly composed of the lock sleeve and the locking piece can quickly realize the locking or unlocking between the lock sleeve and the rope through the movement of the locking piece on the lock sleeve, and the locking force is adjustable; after locking, the locking piece is no longer stressed, and the locking assembly is suitable for being used on a pet leash; after the locking piece is locked, the locking piece will not be loosened in the pulling process, and the locking effect is good.

### BRIEF DESCRIPTION OF DRAWINGS

FIG. 1 is a perspective view of a locking assembly for a rope;

FIG. 2 is a sectional view of FIG. 1;

FIG. 3 is an explosion diagram of FIG. 1;

FIG. 4 is a perspective view of a locking assembly for a rope (the lock sleeve has an extension plate);

FIG. 5 is a perspective view of a pet leash;

FIG. 6 is a perspective view of a pet leash (the lock sleeve has an extension plate);

FIG. 7 is the first schematic diagram when the pet traction rope is tied;

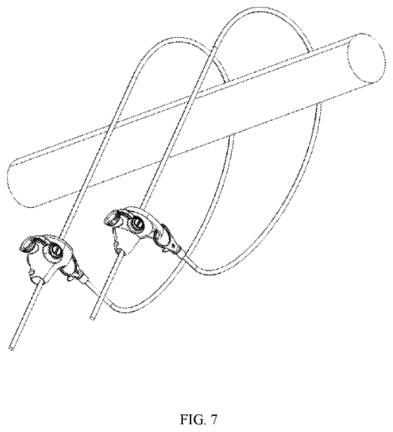

FIG. 8 is the second schematic diagram when the pet leash is tied.

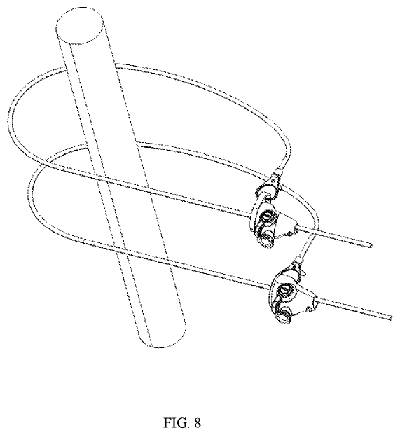

In the figures: 1. Lock sleeve; 11. Threading hole; 12. Lock opening; 13. Threaded hole; 1a, Extension plate; 2. Locking piece; 3. Rope; 4. Lock catch.

### DESCRIPTION OF EMBODIMENTS

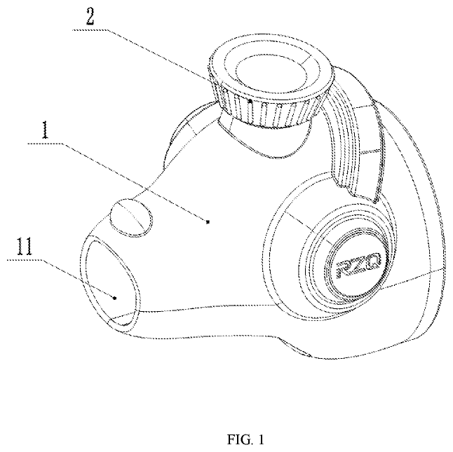

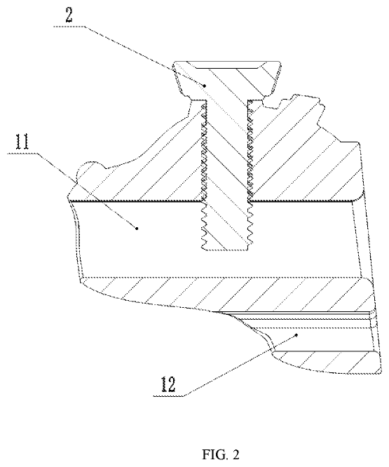

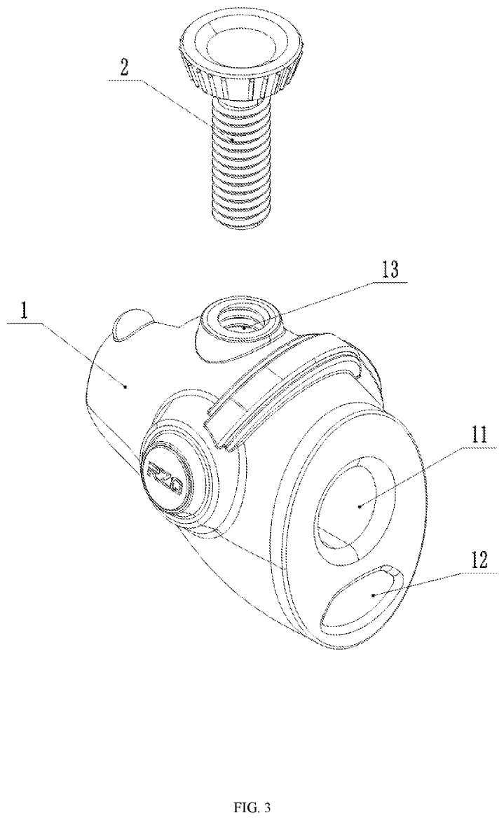

Embodiment 1: as shown in FIG. 1, FIG. 2 and FIG. 3, a locking assembly for a rope according to the embodiment of the present application comprises a lock sleeve 1 and a locking piece 2, wherein the lock sleeve 1 is provided with a threading hole 11 through which a rope 3 can pass, and the locking piece 2 is movably arranged on the lock sleeve 1, and the locking piece 2 can lock or unlock the lock sleeve 1 on the rope 3 through movement, and the lock sleeve 1 is also provided with at least one locking opening 12. The locking piece 2 is a screw, and the lock sleeve 1 is provided with a matching threaded hole 13 corresponding to the screw. The locking opening 12 is arranged below the threading holes 11 in parallel, and the locking opening 12 is flat, and the locking opening 12 runs through the lock sleeve 1.

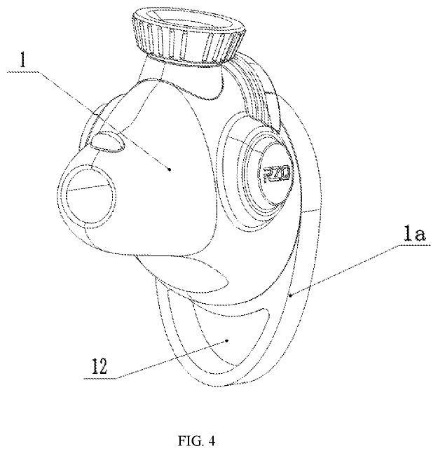

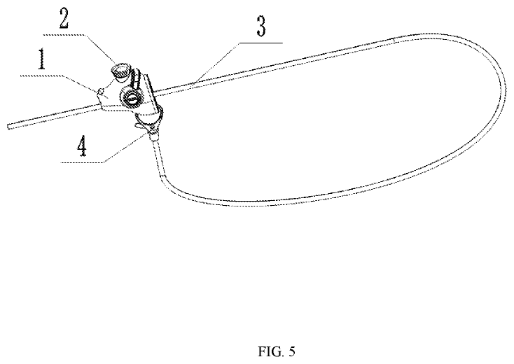

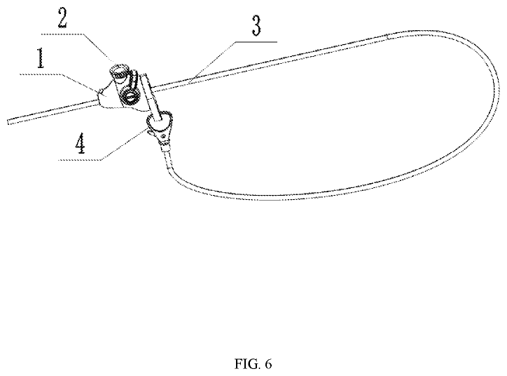

Embodiment 2: as shown in FIG. 4, a locking assembly for a rope according to the embodiment of the present application comprises a lock sleeve 1 and a locking piece 2, wherein the lock sleeve 1 is provided with a threading hole 11 through which a rope 3 can pass, and the locking piece 2 is movably arranged on the lock sleeve 1, and the locking piece 2 can lock or unlock the lock sleeve 1 on the rope 3 through movement, and the lock sleeve 1 is also provided with at least one locking opening 12; the locking piece 2 is a screw, and the lock sleeve 1 is provided with a matching threaded hole 13 corresponding to the screw. The lock sleeve 1 has an integrally formed extension plate 1a, and the locking opening 12 is formed on the extension plate 1a, and the locking opening 12 is crescent-shaped. Embodiment 3: as shown in FIGS. 5 and 6, a pet leash according to the embodiment of the present application includes the locking assembly in Embodiment 1 or Embodiment 2 and a rope 3. One end of the rope 3 is connected to a pet harness or collar, and the other end of the leash 3 is provided with a lock catch 4 which can be buckled on the lock opening 12 of the lock sleeve 1.

The locking assembly composed of the lock sleeve and the locking piece can quickly realize the locking or unlocking between the lock sleeve and the rope through the movement of the locking piece on the lock sleeve. The locking force is adjustable, and after locking, the locking piece is no longer stressed. The locking assembly is suitable for use on a pet leash. After the locking piece is locked, the locking piece will not loosen in the pulling process, and the locking effect is good.

The above is only the preferred embodiment of the present application, and it is not intended to limit the present application. For those skilled in the art, the present application can be modified and varied. Any modification, equivalent substitution, improvement, etc. made within the spirit and principle of the present application shall be included in the scope of protection of the present application.

What is claimed is:

1. A locking assembly for a rope, comprising a lock sleeve and a locking piece, wherein the lock sleeve is provided with a threading hole through which a rope can pass, and the locking piece is movably arranged on the lock sleeve, and the locking piece locks or unlocks the lock sleeve on the rope through movement, and the lock sleeve is also provided with at least one locking opening.

2. The locking assembly for a rope according to claim 1, wherein the locking piece is a screw, the lock sleeve is provided with a matching threaded hole corresponding to the screw, the locking opening is arranged below the threading hole in parallel, the locking opening is flat, and the lock opening runs through the lock sleeve.

3. The locking assembly for a rope according to claim 1, wherein the locking piece is a screw, the lock sleeve is provided with a matching threaded hole corresponding to the screw, the lock sleeve has an integrally formed extension plate, the locking opening is formed on the extension plate, and the lock opening is crescent-shaped.

4. A pet leash, comprising the locking assembly according to claim 1, and a rope, wherein one end of the rope is connected to a pet harness or collar, and the other end of the rope is provided with a lock catch which can be buckled on the lock opening of the lock sleeve.
